(19) United States
(12) Patent Application Publication
(10) Pub. No.: US 2012/0191559 A1
(43) Pub. Date: Jul. 26, 2012

(54) AUCTION SHARING NETWORK

(75) Inventor: Kevin Wood, New Baltimore, MI (US)

(73) Assignee: REI POWERTOOLS, LLC, St. Louis, MO (US)

(21) Appl. No.: 13/012,502

(22) Filed: Jan. 24, 2011

(51) Int. Cl. G06Q 30/00

(52) U.S. Cl. 705/26.3

(57) ABSTRACT

One example embodiment includes a system for sharing auctions. The system includes a database. The database is configured to connect to a first auction portal and a second auction portal. The database is also configured to contain auction data from the first auction portal and the second auction portal. The system also includes a configuration system. The configuration system is configured to allow the first auction portal to determine which auctions from the second auction portal are displayed on the first auction portal. The configuration system is also configured to allow the second auction portal to determine which auctions from the first auction portal are displayed on the second auction portal.

### CROSS-REFERENCE TO RELATED APPLICATIONS

Not applicable.

### BACKGROUND OF THE INVENTION

Real estate or other items are often sold at auction. The point of the auction is to maximize the amount for which the item is sold. In particular, the auction allows the item to be sold for the highest amount offered by a particular group. Auctions can include open bids where participants know the bids of other participants or closed bids where participants submit bids which are kept from the other participants.

Auctions often provide the benefit of maximizing the price and minimizing the time required to sell. If the highest bid equals or exceeds the minimum acceptable selling price then the item is sold. Otherwise, the owner can receive an indication that the minimum asking price is unlikely to be met. Online auctions add convenience to the process. Participants need not physically gather in order to participate in the auction. Additionally, because the potential pool of bidders is larger, the price obtained for the item can be further maximized. That is, because the pool of auction participants is potentially larger, the actual sale price may be greater than would otherwise be the case.

However, online auctions have significant drawbacks. In particular, if an auction site is less well known, the number of participants can be quite small. This may lead to agreements, either actual or implied, by the participants to avoid competition with one another. This can, in turn, significantly lower the price received for the item.

In addition, the greater the number of auction sites, the harder it is for a participant to monitor multiple auction sites. That is, a participant is limited in the number of sites that he or she can actively monitor for new items to purchase or bid on. This, in turn limits the number of visitors to any single site, making each site less effective than it could otherwise be.

Some sites attempt to share the data between auction sites. However, there are a number of problems in the ways in which this data is shared. In particular, the data resides on each individual site. Therefore, in order to share information visitors must either be redirected to another auction site (and may be directed from there to yet another site and so on) or the two sites must share a connection with one another.

If, the visitor is participating from linked sites this means that the sites participating in the auction must rely on the originating site to be able to handle the amount of traffic. That is, if the auction becomes busy and the traffic exceeds the capacity of the originating sites, all other sites participating are unable to continue and participants may blame the connecting sites for problems beyond their control. This will, in turn, discourage sites from sharing auctions from other sites.

In addition, sites are often unable to control the content shown on their own site if linking to other sites. In particular, sites may specialize in real estate auctions of certain types or showing only items that meet certain criteria. That is, the auction may specialize in selling items in certain locations, items that meets certain price criteria or item that meets certain size criteria. By linking to other sites, they may be unable to maintain the same specialization.

Accordingly, there is a need in the art for an auction system that is resilient when faced with heavy traffic. In addition, there is a need in the art for an auction system that allows individual sites to control which auctions from other sites are shown as well as which auctions are shared on the network. Further, there is a need in the art for an auction system that allows visitors to bid on items, even if the items are listed on other auction sites.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for sharing auctions. The system includes a database. The database is configured to connect to a first auction portal and a second auction portal. The database is also configured to contain auction data from the first auction portal and the second auction portal. The system also includes a configuration system. The configuration system is configured to allow the first auction portal to determine which auctions from the second auction portal are displayed on the first auction portal. The configuration system is also configured to allow the second auction portal to determine which auctions from the first auction portal are displayed on the second auction portal.

Another example embodiment includes a system for sharing auctions. The system includes a network, a first auction portal and a second auction portal. The system also includes a database, where the database is configured to contain auction data from the first auction portal and the second auction portal. The system further includes a configuration system. The configuration system is configured to allow the first auction portal to determine which auctions from the second auction portal are displayed on the first auction portal and which auctions from the first auction portal are displayed on the second auction portal. The configuration system is also configured to allow the second auction portal to determine which auctions from the first auction portal are displayed on the second auction portal and which auctions from the second auction portal are displayed on the first auction portal.

Another example embodiment includes a method of sharing auctions. The method includes providing a database. The database is configured to connect to a first auction portal and a second auction portal. The database is also configured to contain auction data from the first auction portal and the second auction portal. The method also includes providing a configuration system. The configuration system is configured to allow the first auction portal to determine which auctions from the second auction portal are displayed on the first auction portal. The configuration system is also configured to allow the second auction portal to determine which auctions from the first auction portal are displayed on the second auction portal.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for sharing auctions;

FIG. 2 illustrates an example of a graphical user interface;

FIG. 3 is a flowchart illustrating a method for sharing auctions;

FIG. 4 is a flowchart illustrating an example a method for providing configuration settings;

FIG. 5 is a flowchart illustrating an alternative example of a method for providing configuration settings;

FIG. 6 is a flowchart illustrating an alternative example of a method for providing configuration settings; and

FIG. 7 illustrates an example of a suitable computing environment in which the invention may be implemented.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

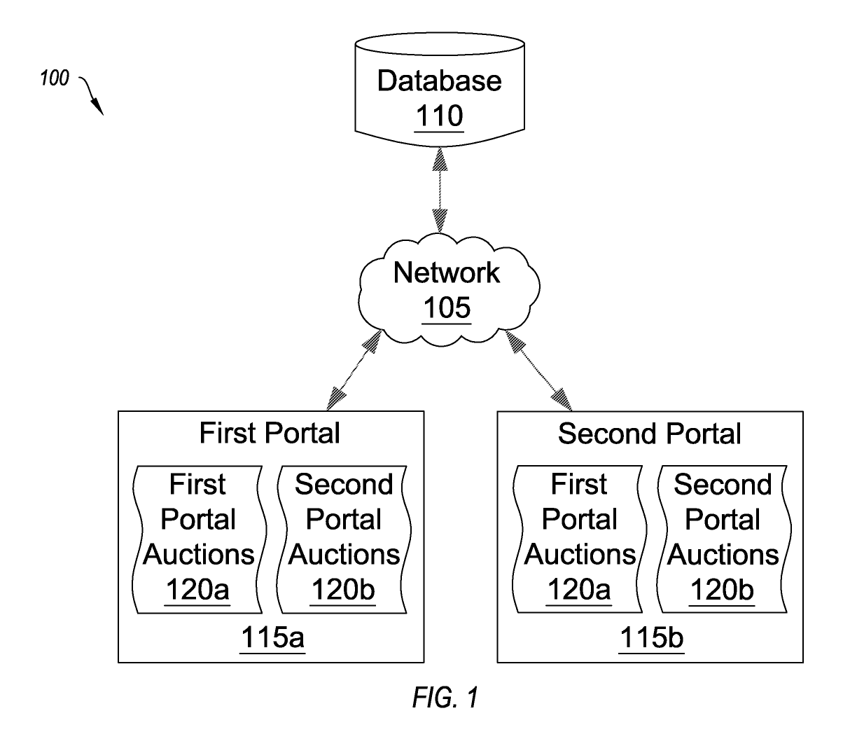

FIG. 1 illustrates an example of a system 100 for sharing auctions. In at least one implementation, the system 100 can be used to share data among auctions. In at least one implementation, sharing data facilitates a wider audience exposure for each individual auction being shared. This can result in more interest in the item being auctioned and bidding activity and increase the return on the sold item. For example, the system 100 can be used to share data among real estate auctions. One of skill in the art will appreciate that while real estate auctions are treated as exemplary herein the system 100 can be used for any auction type unless otherwise specified.

FIG. 1 shows that the system 100 can include a network 105. In at least one implementation, the network 105 can be used to connect the various parts of the system 100 to one another. The network 105 exemplarily includes the Internet, including a global internetwork formed by logical and physical connections between multiple wide area networks and/or local area networks and can optionally include the World Wide Web (“Web”), including a system of interlinked hypertext documents accessed via the Internet. Alternately or additionally, the network 105 includes one or more cellular RF networks and/or one or more wired and/or wireless networks such as, but not limited to, 802.xx networks, Bluetooth access points, wireless access points, IP-based networks, or the like. For example, the network 105 can include cloud based networking and computing. The network 105 can also include servers that enable one type of network to interface with another type of network.

FIG. 1 also shows that the system 100 can include a database 110. In at least one implementation, the database 110 can store auction data. In particular, the database 110 can include any device that is capable of storing data. The data can be stored in digital form or in any other form. For example the database 110 can include memory or memory banks.

Additionally or alternatively, the database 110 can run one or more applications which are accessed over the network 105. For example, the database 110 can include processors or other logic devices capable of executing software or carrying out other computer algorithms. The database 110 can allow a user to access the hardware of the database 110 for remote computing or for information retrieval.

FIG. 1 further shows that the system 100 can include a first portal 115a and a second portal 115b (collectively “portals 115”). In at least one implementation, the portals 115 can connect to the database 110 over the network 105. In particular, the portals 115 can either upload data to the database 110 over the network 105 or download data from the database 110 over the network 105.

In at least one implementation, the system 100 can include additional portals 115. In particular, the system 100 can be scaled to include any number of portals 115. The portals 115 can access data from the database 110 which can allow each portal 115 to access the necessary data independent of other portals 115. I.e., portals can connect to the database 110 rather than other portals 115.

In at least one implementation, the portals 115 can include web pages. It should be noted that “web page” as used herein refers to any online posting, including domains, subdomains, Web posts, Uniform Resource Identifiers (“URIs”), Uniform Resource Locators (“URLs”), images, videos, or other piece of content and non-permanent postings such as e-mail and chat unless otherwise specified. Additionally or alternatively, the portals 115 can include a mobile device/mobile applications or other hardware or software for uploading or downloading data from the database 110.

In at least one implementation, the portals 115 can include a graphical user interface. The graphical user interface can allow a user at the first portal to enter auction data to be stored in the database 110. In particular, a visitor to a web page that acts as the first portal 115a or the second portal 115b can enter auction data which can be saved to the database 110. Additionally or alternatively, the graphical user interface can allow a visitor to a web page to view auction data from the database, as described below.

In at least one implementation, the first portal 115a can show all first portal auctions 120a. I.e., all first portal auctions 120a, auctions entered on the first portal 115a, can be shown on the first portal 115a. Additionally or alternatively, the first portal 115a can be configured to show second portal auctions 120b. The first portal 115a can show all second portal auctions 120b or only a portion thereof, as determined by the administrator of the first portal 115a, as described below.

Likewise, the second portal 115b can show all second portal auctions 120b. I.e., all second portal auctions 120b, auctions entered on the second portal 115b, can be shown on the second portal 115b. Additionally or alternatively, the second portal 115b can be configured to show first portal auctions 120a. The second portal 115b can show all first portal auctions 120a or only a portion thereof, as determined by the administrator of the second portal 115b, as described below.

In at least one implementation, visitors to any portal 115 showing data relating to a particular auction can bid on the auction. I.e., visitors to the first portal 115a can be allowed to bid on second portal auctions 120b without being transferred to the second portal 115b. For example, a visitor to the first portal 115a can bid on a second portal auction 120b without visiting the web page associated with the second portal 115b or downloading any software associated with the second portal 115b.

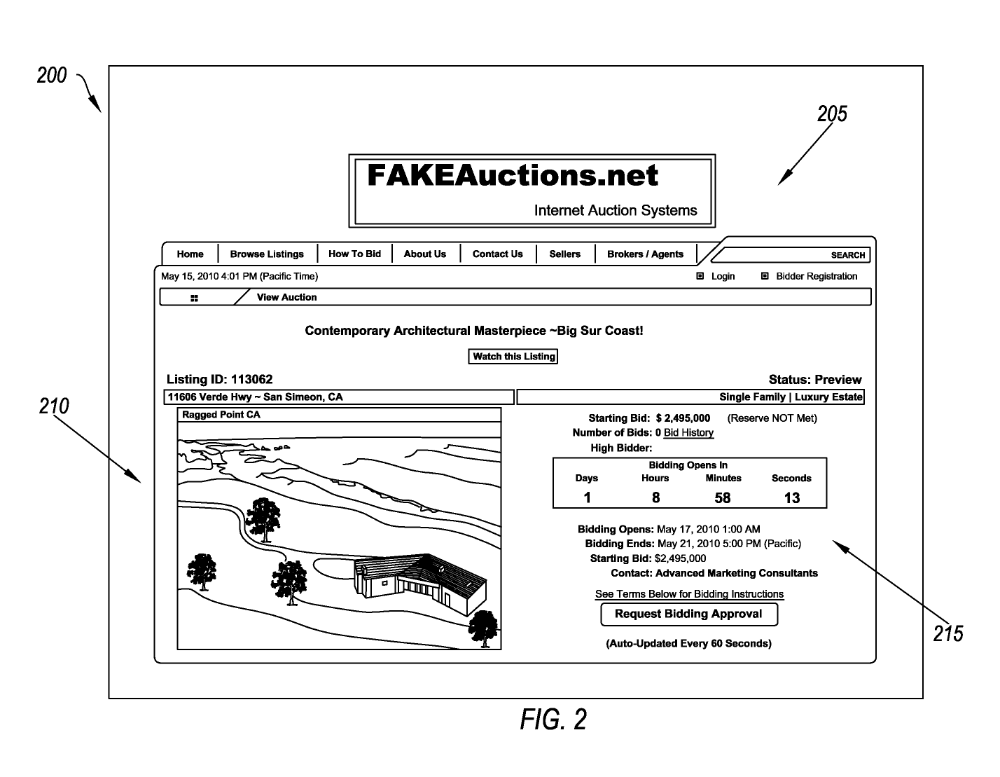

FIG. 2 illustrates an example of a graphical user interface 200. In at least one implementation, the graphical user interface 200 can be used with the system 100 of FIG. 1. For example, the graphical user interface 200 can be used to allow a user to enter or view data in one of the portals 115 of the system 100. One of skill in the art, however, will appreciate that the graphical user interface 200 can be used with systems other than the system 100 of FIG. 1. One of skill in the art will further appreciate that although the graphical user interface 200 shows a real estate auction, the graphical user interface 200 can be used with any auction.

FIG. 2 shows that the graphical user interface can include a skin 205. In at least one implementation, the skin 205 includes a custom graphical appearance. I.e., the skin 205 can include the appearance of the graphical user interface 200. For example, if the graphical user interface 200 is part of a web page, the skin 205 can include the web page name or other design elements. Additionally or alternatively, the skin 205 can include a minimalist design meant to solicit the necessary information to save or retrieve the required data.

FIG. 2 also shows that the graphical user interface 200 can include auction data 210. In at least one implementation, the auction data 210 can include information regarding the item to be sold. For example, the auction data 210 can include the location of the item, item details, the starting bid, the minimum bid increase, the portal auction id number, the database auction id number, the auction status or any other desired auction data 210.

In at least one implementation, the graphical user interface 200 can display all of the auction data 210 stored in the database for the auction. Additionally or alternatively, each portal can configure the graphical user interface 200 to display a portion of the auction data 210. For example, the graphical user interface 200 can be configured to show or not show the database auction id number.

FIG. 2 further shows that the graphical user interface 200 can include auction time data 215. In at least one implementation, the auction time data 215 can include when bidding begins and when bidding ends. Additionally or alternatively, the auction time data 215 can include an indicator of when bidding will begin or when bidding will end.

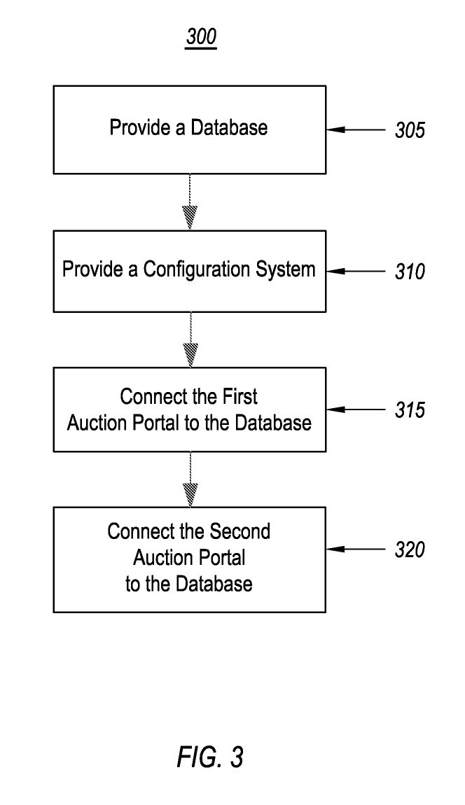

FIG. 3 is a flowchart illustrating a method 300 for sharing auctions. One of skill in the art will appreciate that the method 300 can be used with the system 100 of FIG. 1; however, the method 300 can be used with a system other than the system 100 of FIG. 1.

FIG. 3 shows that the method 300 can include providing a database 305. In at least one implementation, the database can store auction data. In particular, the database can include any device that is capable of storing data. The data can be stored in digital form or in any other form. For example the database can include memory or memory banks.

In at least one implementation, the database is configured to provide data to and receive data from a first auction portal and a second auction portal. For example, the database can be configured to contain auction data from the first auction portal and the second auction portal. I.e., a user can enter auction data into either the first portal or second portal which then sends the information to the database.

FIG. 3 also shows that the method 300 can include providing a configuration system. In at least one implementation, the configuration system can be configured to allow the first auction portal to determine which auctions from the second auction portal are displayed on the first auction portal. Additionally or alternatively, the configuration system can be configured to allow the second auction portal to determine which auctions from the first auction portal are displayed on the second auction portal, as described below.

In at least one implementation, the configuration system can be configured to allow the first auction portal to determine which auctions from the first auction portal are displayed on the second auction portal. I.e., the first auction portal can allow only certain auctions from the first auction portal to be shown on other portals as determined by the administrator of the first auction portal, as described below. Additionally or alternatively, the configuration system can be configured to allow the second auction portal to determine which auctions from the second auction portal are displayed on the first auction portal.

FIG. 3 further shows that the method 300 can include connecting the first auction portal to the database 315. In at least one implementation, the first auction portal can connect to the database over a network. For example, the first auction portal can include a web page connected to the database over the Internet. Additionally or alternatively, the first auction portal can include a software application which is configured to upload data to the database or download data from the database.

FIG. 3 also shows that the method 300 can include connecting the second auction portal to the database 320. In at least one implementation, the second database can be connected to the database in the same manner as the first auction portal. Additionally or alternatively, the second database can be connected in a manner different than the first auction portal. For example, the first database can be connected via the Internet and the second database can be connected via phone line.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

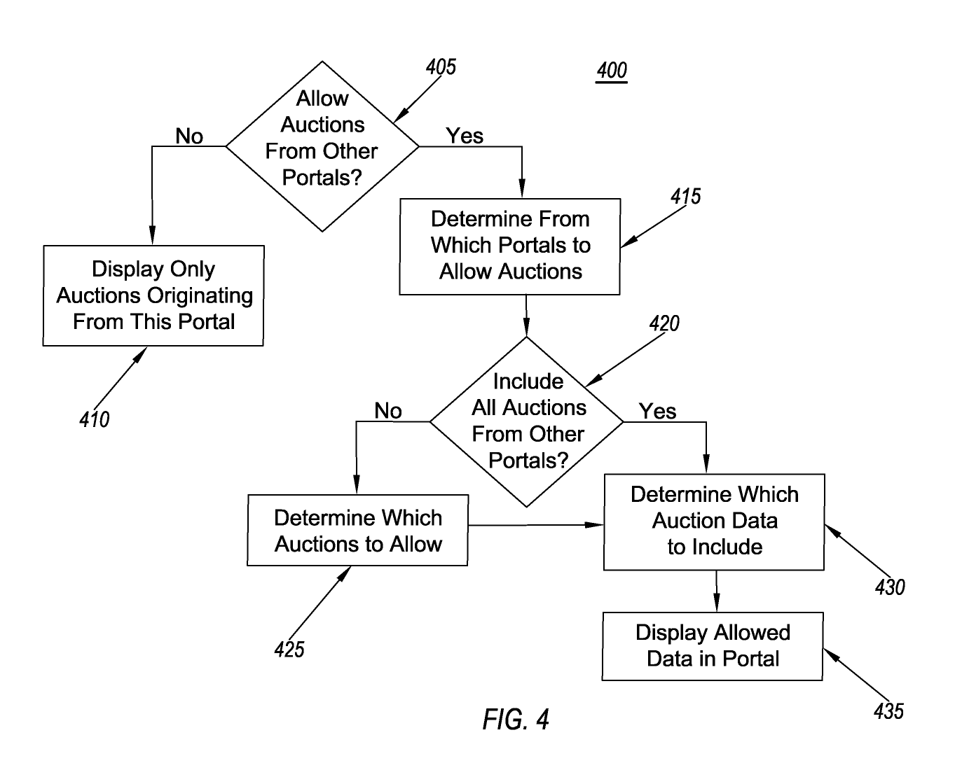

FIG. 4 is a flowchart illustrating an example a method 400 for providing configuration settings. In at least one implementation, configuration settings can be controlled by portal administrators. For example, the configuration settings can allow the portal administrators to determine which, if any, auctions are shown on the portal. In particular, the configuration system can allow the portal administrator to block auctions from other portals or limit the number of auctions from other portals, as described below.

FIG. 4 shows that the method 400 includes deciding whether auctions are allowed from other portals 405. In at least one implementation, the portal administrator can allow auctions from other portals to display. Additionally or alternatively, the portal administrator can block auctions originating on other portals from displaying on the portal, as described below.

FIG. 4 also shows that the method includes displaying only auctions originating from the portal 410 if auctions from other portals are not allowed. In at least one implementation, even if auctions from other portals are not allowed, auctions originating in the current portal can be shown on other portals. For example, the portal may not be configured to allow the actual auction, but instead to post auctions on other portals so configured.

FIG. 4 further shows that the method 400 can include determining from which portals to allow auctions 415. In at least one implementation, the portal administrator can allow or disallow each external portal individually. Additionally or alternatively, the portal administrator can allow portals based on some criteria. For example, the portal administrator can allow all external portals that sell real estate within certain geographical areas or in certain price ranges, or only properties meeting other criteria such as square footage, acreage, number of bedrooms, etc.

FIG. 4 also shows that the method 400 can include deciding whether to include all auctions from allowed portals 420. In at least one implementation, the portal administrator can allow all auctions from the allowed external portals. Additionally or alternatively, the portal administrator can allow only a subset of auctions to be displayed, as described below.

FIG. 4 further shows that the method 400 can include determining which auctions to allow 425 if all auctions are not included from allowed portals. In at least one implementation, the portal administrator can require that auctions be individually approved or that only auctions meeting certain criteria be allowed. For example the portal administrator can allow only auctions within certain geographical or price ranges, or only properties meeting other criteria such as square footage, acreage, number of bedrooms, etc.

FIG. 4 also shows that the method 400 can include determining which auction data to include 430. In at least one implementation, the auction data can include all data from all allowed auctions, or only a portion of the data from the auctions allowed by the portal administrator. For example, the auction data can include the location of the item, item details, the starting bid, the minimum bid increase, the portal auction id number, the database auction id number, the auction status or any other desired auction data. In at least one implementation, the portal can display all of the auction data stored in the database for the auction. Additionally or alternatively, each portal can be configured to display a portion of the auction data. For example, the portal can be configured to show or not show the database auction id number.

FIG. 4 further shows that method 400 can include displaying the allowed data on the portal 435. In at least one implementation, the displayed data can allow a visitor to the portal to bid on the auctions. In particular, the displayed data can allow the visitor to bid on the auctions without having to visit or connect directly to the portal on which the auction originated.

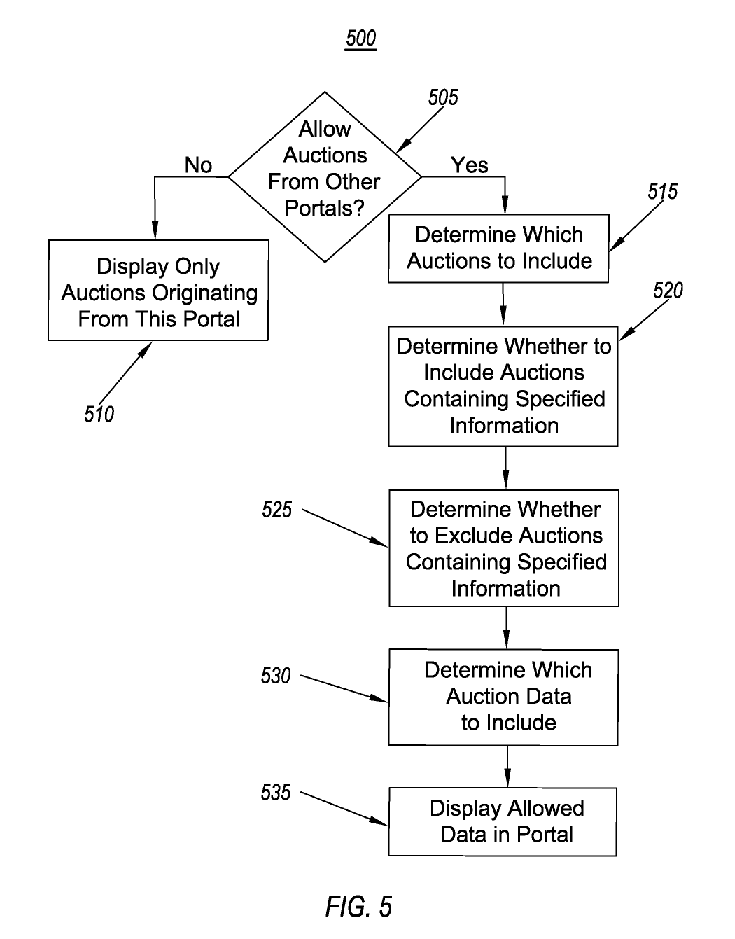

FIG. 5 is a flowchart illustrating an alternative example of a method 500 for providing configuration settings. In at least one implementation, configuration settings can be controlled by portal administrators. For example, the configuration settings can allow the portal administrators to determine which, if any, auctions are shown on the portal. In particular, the configuration system can allow the portal administrator to block auctions from other portals or limit the number of auctions from other portals, as described below.

FIG. 5 also shows that the method includes displaying only auctions originating from the portal 510 if auctions from other portals are not allowed. In at least one implementation, even if auctions from other portals are not allowed, auctions originating in the current portal can be shown on other sites. For example, the portal may not be configured to allow the actual auction, but instead to post auctions on other portals so configured.

FIG. 5 further shows that the method 500 can include determining which auctions to allow 515 if auctions are allowed from other portals. In at least one implementation, the portal administrator can require that auctions be individually approved or that only auctions meeting certain criteria be allowed. For example the portal administrator can allow only auctions within certain geographical or price ranges, or only items meeting other criteria such as square footage, acreage, number of bedrooms, etc.

FIG. 5 also shows that the method 500 can include determining whether to include auctions containing specified information 520. In at least one implementation, the specified information can include any information about the auction. For example, the specified information can include certain geographical or price ranges, or only items meeting other criteria such as square footage, acreage, number of bedrooms, etc.

FIG. 5 further shows that the method 500 can include determining whether to exclude auctions containing specified information 525 whether or not auctions are included that contain specified information. In at least one implementation, the specified information can include any information about the auction. For example, the specified information can include certain geographical or price ranges, or only items meeting other criteria such as square footage, acreage, number of bedrooms, etc.

FIG. 5 also shows that the method 500 can include determining which auction data to include 530. The auction data can include data from all auctions from allowed portals, or only the auctions allowed by the portal administrator. For example, the auction data can include the location of the item, item details, the starting bid, the minimum bid increase, the portal auction id number, the database auction id number, the auction status or any other desired auction data. In at least one implementation, the portal can display all of the auction data stored in the database for the auction. Additionally or alternatively, each portal can be configured to display a portion of the auction data. For example, the portal can be configured to show or not show the database auction id number.

FIG. 5 further shows that method 500 can include displaying the allowed data on the portal 535. In at least one implementation, the displayed data can allow a visitor to the portal to bid on the auctions. In particular, the displayed data can allow the visitor to bid on the auctions without having to visit or connect directly to the portal on which the auction originated.

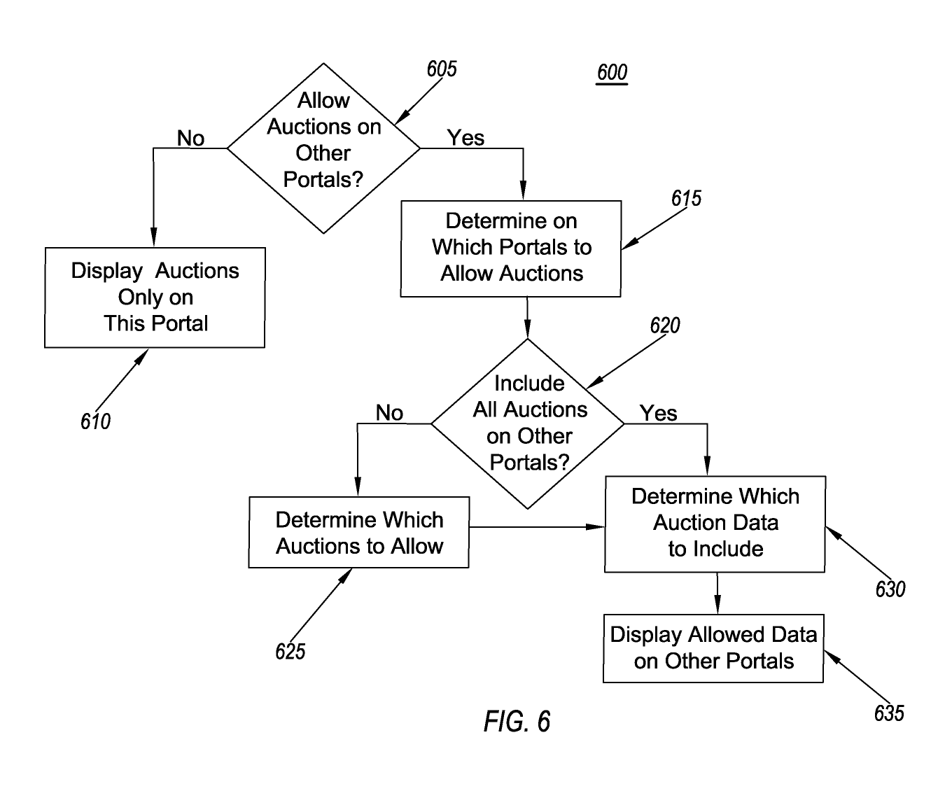

FIG. 6 is a flowchart illustrating an alternative example of a method 600 for providing configuration settings. In at least one implementation, configuration settings can be controlled by portal administrators. For example, the configuration settings can allow the portal administrators to determine which, if any, auctions are shown on other portal. In particular, the configuration system can allow the portal administrator to block auctions from being shown on other portals or limit the number of auctions shown on other portals, as described below.

FIG. 6 shows that the method 600 includes deciding whether auctions are allowed on other portals 605. In at least one implementation, the portal administrator can allow auctions to display on other portals. Additionally or alternatively, the portal administrator can block auctions originating on the portal from displaying on other portals, as described below.

FIG. 6 also shows that the method includes displaying auctions on the originating portal 610 if auctions are not allowed on other portals. In at least one implementation, even if auctions on other portals are not allowed, auctions originating in others portals can be shown on the portal. For example, the portal may be configured to post auctions from other portals.

FIG. 6 further shows that the method 600 can include determining on which portals to allow auctions 615. In at least one implementation, the portal administrator can allow or disallow auctions from each external portal individually. Additionally or alternatively, the portal administrator can allow auctions on other portals based on some criteria. For example, the portal administrator can allow all external portals that sell real estate within certain geographical areas or in certain price ranges, or only properties meeting other criteria such as square footage, acreage, number of bedrooms, etc.

FIG. 6 also shows that the method 600 can include deciding whether to include all auctions on allowed portals 620. In at least one implementation, the portal administrator can allow all auctions on the allowed external portals. Additionally or alternatively, the portal administrator can allow only a subset of auctions to be displayed, as described below.

FIG. 6 further shows that the method 600 can include determining which auctions to allow 625 if all auctions are not included on allowed portals. In at least one implementation, the portal administrator can require that auctions be individually approved or that only auctions meeting certain criteria be allowed. For example the portal administrator can allow only auctions within certain geographical or price ranges, or only properties meeting other criteria such as square footage, acreage, number of bedrooms, etc.

FIG. 6 also shows that the method 600 can include determining which auction data to include 630. In at least one implementation, the auction data can include all data from all allowed auctions, or only a portion of the data from the auctions allowed by the portal administrator. For example, the auction data can include the location of the item, item details, the starting bid, the minimum bid increase, the portal auction id number, the database auction id number, the auction status or any other desired auction data. In at least one implementation, the portal can display all of the auction data stored in the database for the auction. Additionally or alternatively, each portal can be configured to display a portion of the auction data. For example, the portal can be configured to show or not show the database auction id number.

FIG. 6 further shows that method 600 can include displaying the allowed data on the other portals 635. In at least one implementation, the displayed data can allow a visitor to the portal to bid on the auctions. In particular, the displayed data can allow the visitor to bid on the auctions without having to visit or connect directly to the portal on which the auction originated.

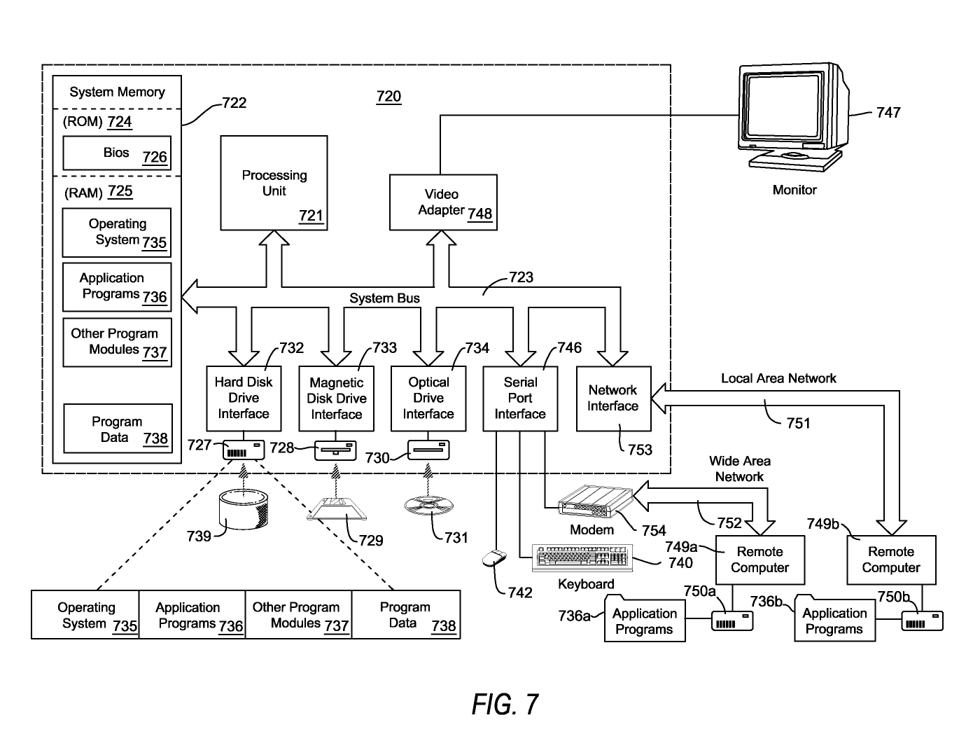

FIG. 7, and the following discussion, is intended to provide a brief, general description of a suitable computing environment in which the invention may be implemented. Although not required, the invention will be described in the general context of computer-executable instructions, such as program modules, being executed by computers in network environments. Generally, program modules include routines, programs, objects, components, data structures, etc. that performs particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

One skilled in the art will appreciate that the invention may be practiced in network computing environments with many types of computer system configurations, including personal computers, hand-held devices, mobile phones, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 7, an example system for implementing the invention includes a general purpose computing device in the form of a conventional computer 720, including a processing unit 721, a system memory 722, and a system bus 723 that couples various system components including the system memory 722 to the processing unit 721. It should be noted however, that as mobile phones become more sophisticated, mobile phones are beginning to incorporate many of the components illustrated for conventional computer 720. Accordingly, with relatively minor adjustments, mostly with respect to input/output devices, the description of conventional computer 720 applies equally to mobile phones. The system bus 723 may be any of several types of bus structures including a memory bus or memory controller, a peripheral bus, and a local bus using any of a variety of bus architectures. The system memory includes read only memory (ROM) 724 and random access memory (RAM) 725. A basic input/output system (BIOS) 726, containing the basic routines that help transfer information between elements within the computer 720, such as during start-up, may be stored in ROM 724.

The computer 720 may also include a magnetic hard disk drive 727 for reading from and writing to a magnetic hard disk 739, a magnetic disk drive 728 for reading from or writing to a removable magnetic disk 729, and an optical disc drive 730 for reading from or writing to removable optical disc 731 such as a CD-ROM or other optical media. The magnetic hard disk drive 727, magnetic disk drive 728, and optical disc drive 730 are connected to the system bus 723 by a hard disk drive interface 732, a magnetic disk drive-interface 733, and an optical drive interface 734, respectively. The drives and their associated computer-readable media provide nonvolatile storage of computer-executable instructions, data structures, program modules and other data for the computer 720. Although the exemplary environment described herein employs a magnetic hard disk 739, a removable magnetic disk 729 and a removable optical disc 731, other types of computer readable media for storing data can be used, including magnetic cassettes, flash memory cards, digital versatile discs, Bernoulli cartridges, RAMs, ROMs, and the like.

Program code means comprising one or more program modules may be stored on the hard disk 739, magnetic disk 729, optical disc 731, ROM 724 or RAM 725, including an operating system 735, one or more application programs 736, other program modules 737, and program data 738. A user may enter commands and information into the computer 720 through keyboard 740, pointing device 742, or other input devices (not shown), such as a microphone, joy stick, game pad, satellite dish, scanner, or the like. These and other input devices are often connected to the processing unit 721 through a serial port interface 746 coupled to system bus 723. Alternatively, the input devices may be connected by other interfaces, such as a parallel port, a game port or a universal serial bus (USB). A monitor 747 or another display device is also connected to system bus 723 via an interface, such as video adapter 748. In addition to the monitor, personal computers typically include other peripheral output devices (not shown), such as speakers and printers.

The computer 720 may operate in a networked environment using logical connections to one or more remote computers, such as remote computers 749a and 749b. Remote computers 749a and 749b may each be another personal computer, a server, a router, a network PC, a peer device or other common network node, and typically include many or all of the elements described above relative to the computer 720, although only memory storage devices 750a and 750b and their associated application programs 736a and 736b have been illustrated in FIG. 7. The logical connections depicted in FIG. 7 include a local area network (LAN) 751 and a wide area network (WAN) 752 that are presented here by way of example and not limitation. Such networking environments are commonplace in office-wide or enterprise-wide computer networks, intranets and the Internet.

When used in a LAN networking environment, the computer 720 can be connected to the local network 751 through a network interface or adapter 753. When used in a WAN networking environment, the computer 720 may include a modem 754, a wireless link, or other means for establishing communications over the wide area network 752, such as the Internet. The modem 754, which may be internal or external, is connected to the system bus 723 via the serial port interface 746. In a networked environment, program modules depicted relative to the computer 720, or portions thereof, may be stored in the remote memory storage device. It will be appreciated that the network connections shown are exemplary and other means of establishing communications over wide area network 752 may be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for sharing auctions, the system comprising:
a database, wherein the database is configured to connect to:
a first auction portal; and
a second auction portal;
wherein the database is configured to contain auction data from the first auction portal and the second auction portal; and
a configuration system, wherein the configuration system is configured to:
allow the first auction portal to determine which auctions from the second auction portal are displayed on the first auction portal; and
allow the second auction portal to determine which auctions from the first auction portal are displayed on the second auction portal.

2. The system of claim 1, further comprising a content management system.

3. The system of claim 2, wherein the content management system is configured to provide a framework for displaying the auctions on the first auction portal and the second auction portal.

4. The system of claim 1, wherein the first auction portal can access the configuration system to change which auctions from the second auction portal are displayed on the first auction portal.

5. The system of claim 4, wherein the second auction portal can access the configuration system to change which auctions from the first auction portal are displayed on the second auction portal.

6. The system of claim 1, wherein the first auction portal can add auction data to the database.

7. The system of claim 6, wherein the first auction portal can remove auction data from the database.

8. The system of claim 6, wherein the second auction portal can add auction data to the database.

9. A system for sharing auctions, the system comprising:
a network;
a first auction portal;
a second auction portal;
a database, wherein the database is configured to contain auction data from the first auction portal and the second auction portal; and
a configuration system, wherein the configuration system is configured to:
allow the first auction portal to determine:
which auctions from the second auction portal are displayed on the first auction portal; and
which auctions from the first auction portal are displayed on the second auction portal; and
allow the second auction portal to determine:
which auctions from the first auction portal are displayed on the second auction portal; and
which auctions from the second auction portal are displayed on the first auction portal.

10. The system of claim 9, wherein the first auction portal includes a first website.

11. The system of claim 10, wherein the first website includes a graphical user interface.

12. The system of claim 10, wherein the second auction portal includes a second website.

13. The system of claim 12, wherein the second website includes a graphical user interface.

14. A method of sharing auctions, the method comprising:
providing a database, wherein the database is configured to connect to:
a first auction portal; and
a second auction portal;
wherein the database is configured to contain auction data from the first auction portal and the second auction portal; and
providing a configuration system, wherein the configuration system is configured to:
allow the first auction portal to determine which auctions from the second auction portal are displayed on the first auction portal; and
allow the second auction portal to determine which auctions from the first auction portal are displayed on the second auction portal

15. The method of claim 14 further comprising connecting the first auction portal over a network.

16. The method of claim 15 further comprising connecting the second auction portal over the network.

17. The method of claim 14, wherein at least a portion of the auction data originates in one of:
the first auction portal; and
the second auction portal.

18. The method of claim 17, wherein a visitor the second auction portal is able to bid on an auction originating in the first auction portal.

19. The method of claim 17, wherein a visitor the first auction portal is able to bid on an auction originating in the second auction portal.

20. The method of claim 14, wherein the first auction portal includes:
a software application, wherein the software application is configured to connect to the database.
